(19) United States
(12) Patent Application Publication
(10) Pub. No.: US 2007/0045128 A1
(43) Pub. Date: Mar. 1, 2007

(54) CHLORINE DIOXIDE SENSOR

(75) Inventors: Brian C. Krafthefer, Stillwater, MN (US); Michael L. Rhodes, Richfield, MN (US); Yuandong Gu, Plymouth, MN (US); Peter Tobias, Minnetonka, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/465,359

(22) Filed: Aug. 17, 2006

Related U.S. Application Data
(60) Provisional application No. 60/709,863, filed on Aug. 19, 2005.

(51) Int. Cl. G01N 27/26; G01F 1/64

(52) U.S. Cl. 205/778.5; 204/416; 205/785.5

(57) ABSTRACT

A sensor is disclosed that includes an electrolyte pump in fluid communication with an electrochemical cell and an ion selective electrode. The electrochemical cell may include a gold cathode and a platinum anode. The sensor may include an electrolyte reservoir as well as an optional electrolyte waste reservoir. Methods of sensing chlorine dioxide are also disclosed.

### PRIORITY

This application claims benefit under 35 U.S.C.§119(e) to provisional patent application Ser. No. 60/709,863, entitled “CHLORINE DIOXIDE SENSOR” filed Aug. 19, 2005.

### TECHNICAL FIELD

The present disclosure generally relates to chlorine dioxide sensors and methods of determining the concentration of chlorine dioxide in an atmosphere.

### BACKGROUND

Chlorine dioxide (ClO₂) is a chlorine-containing hazardous gas, whose maximum workplace concentration value is in the range of 0.1 parts per million by volume. Chlorine dioxide is manufactured on a large scale, and can be used as a substitute for chlorine or ozone in many applications. Its uses include biocide applications and disinfection applications, for example. While some chlorine dioxide sensors are known, a need remains for improved chlorine dioxide sensors.

### SUMMARY

The present invention generally relates to chlorine dioxide gas sensors and methods of determining the concentration of chlorine dioxide in a gaseous atmosphere. An example of the present invention may be found in a chlorine dioxide sensor that includes an electrolyte flow channel and a gas permeable membrane that is disposed adjacent the electrolyte flow channel. A gold cathode and a platinum anode may be disposed within the electrolyte flow channel. An electrostatically actuated pump may be disposed in fluid communication with the electrolyte flow channel. An ion selective electrode may be disposed within the electrolyte flow channel downstream of the gold cathode.

In some instances, the gold cathode and the platinum anode may be inter-digitized and thus both may be disposed adjacent the gas permeable membrane. In some cases, the gold cathode may be disposed adjacent the gas permeable membrane while the platinum anode may be disposed across the flow channel from the gold cathode. The gold cathode may be a gold mesh or a gold plated mesh, if desired.

The chlorine dioxide sensor may include an electrolyte reservoir that is disposed upstream of the gold cathode in fluid communication with the electrostatically actuated pump. In some cases, the electrolyte reservoir may be configured to configured to contain about 0.1 to about 1 milliliter of an electrolyte including a chlorate salt and/or a perchlorate salt. In some cases, an electrolyte waste reservoir may be disposed downstream of the ion selective electrode. The electrostatically actuated pump may be configured to pump electrolyte at a rate that ranges from about 1 nanoliter per hour to about 100 nanoliters per hour.

In some cases, there may be an upstream Ag/AgCl reference electrode that disposed upstream of the gold cathode. If desired, a downstream Ag/AgCl reference electrode may be disposed downstream of the ion selective electrode. In some instances, a chlorine dioxide detection network may be formed by combining a number of chlorine dioxide sensors in communication with a wired or wireless network.

Another illustrative but non-limiting example of the present invention may be found in a sensor that includes an electrochemical cell, an ion selective electrode and a pump that is in fluid communication with the electrochemical cell and the ion selective electrode. In some cases, the sensor may also include an upstream reference electrode that is disposed upstream of the electrochemical cell and/or a downstream reference electrode that is disposed downstream of the ion selective electrode.

In some instances, the electrochemical cell may include a flow channel and a gas permeable membrane that is in fluid communication with the flow channel. The electrochemical cell may also include a gold cathode and a platinum anode disposed in the flow channel.

Another illustrative but non-limiting example of the present invention may be found in a method of detecting chlorine dioxide in an atmosphere. An electrolyte may be pumped through an electrochemical cell that includes a flow channel, a gas permeable membrane that is disposed adjacent the flow channel, a gold cathode and a platinum anode that are disposed in the flow channel. If desired, the electrolyte flow rate may be varied by changing the pumping rate.

The gas permeable membrane may be exposed to the atmosphere, thereby permitting chlorine dioxide, if present in the atmosphere, to diffuse through the gas permeable membrane and into the electrolyte. Any chlorine dioxide that diffuses into the electrolyte may be reduced into chloride ions at the gold cathode. The chloride ion concentration within the electrolyte may be used to determine the chlorine dioxide concentration.

In some cases, the chloride ion concentration may be determined by measuring a direct amperometric output from the electrochemical cell. In some cases, the chloride ion concentration may be determined by measuring a voltage at a first downstream reference electrode that is disposed downstream of the electrochemical cell. In some instance, a voltage measured at a reference electrode that is upstream of the electrochemical cell may be subtracted. If desired, a second downstream reference electrode disposed downstream of the electrochemical cell may be used to account for spatial concentration differences in chloride ion concentration. In some instances, energy may be applied to the electrolyte to release a known amount of chloride ions for calibration purposes.

These and other aspects of the present application will be apparent from the detailed description below. In no event, however, should the above summaries be construed as limitations on the claimed subject matter, which subject matter is defined by the attached claims.

### BRIEF DESCRIPTION OF THE DRAWINGS

The invention may be more completely understood in consideration of the following detailed description of various embodiments of the invention in connection with the accompanying drawings, in which:

FIG. 1 is an illustrative but non-limiting schematic diagram of a sensor;

FIG. 2 is an illustrative but non-limiting schematic perspective view of an electrochemical cell; and

FIG. 3 is an illustrative but non-limiting schematic diagram of a portion of a sensor.

While the invention is amenable to various modifications and alternative forms, specifics thereof have been shown by way of example in the drawings and will be described in detail. It should be understood, however, that the intention is not to limit the invention to the particular illustrative embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials may be illustrated for the various elements, those skilled in the art will recognize that many of the examples provided have suitable alternatives that may be utilized.

The present invention pertains to chlorine dioxide gas sensors and methods of determining the concentration of chlorine dioxide in a gaseous atmosphere. While the present invention is not so limited, an appreciation of various aspects of the invention will be gained through a discussion of the various illustrative embodiments and examples provided below.

In some embodiments, the sensors described herein are used in applications that require measurement of chlorine or chlorine dioxide in a dynamic range from, for example, 10 weight percent to 0.1 parts per million or less.

For example, and in one illustrative application, decontamination of an enclosed space from biological threats may require a strong oxidizing agent such as chlorine dioxide (ClO₂). The sensors described herein are able to monitor levels of chlorine and/or chlorine dioxide during the decontamination process to determine when sufficient decontamination agent has been introduced in to the enclosed space (e.g. about 10 weight percent), and when it is safe for individuals to re-occupy the decontaminated enclosed space (e.g. less than 0.1 parts per million or less).

It is contemplated that multiple sensors can be placed in the enclosed space and be connected via a wired or wireless communication path to monitor the distribution of decontamination agent, if desired. It is contemplated that a plurality of sensors could be placed within an enclosed space in anticipation of a future need to monitor chlorine dioxide concentration. In some instances, it is considered that sensors could be placed within an enclosed space, by one or more individuals wearing appropriate protective gear, after a monitoring need has arisen. While this is one example application, it is contemplated that the sensors described herein may be used in any suitable application, as desired.

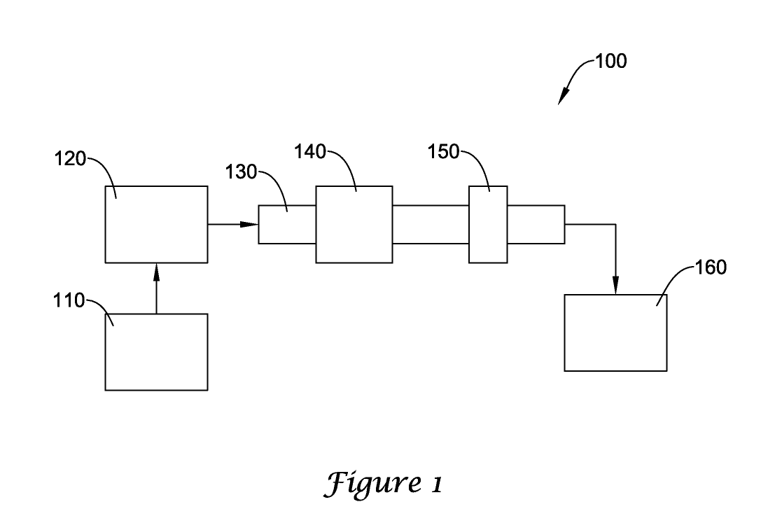

FIG. 1 is a schematic diagram of an illustrative sensor 100. Illustrative sensor 100 includes a pump 120 in fluid communication with an electrochemical cell 140 and an ion selective electrode 150. In many embodiments, electrochemical cell 140, pump 120 and ion selective electrode 150 are in fluid communication via an electrolyte flow channel 130. The pump 120 may be any type of pump including a micro-pump or any other suitable pump. In some cases, the pump 120 may be an electostatically actuated micro-pump as described in, for example, U.S. Pat. Nos. 6,767,190, 6,729,856, 6,179,586, 6,106,245, and 5,836,750, all of which are incorporated herein by reference. The pump 120 may be used to pump an electrolyte through the electrolyte flow channel 130.

In some instances, electrochemical cell 140 is disposed between electrolyte pump 120 and ion selective electrode 150 (as shown), but this is not required. In the illustrated embodiment shown in FIG. 1, electrolyte pump 120 may be considered as being upstream of electrolyte flow channel 130 while ion selective electrode 150 may be considered as being downstream of electrolyte flow channel 130. In this, upstream and downstream are used to identify spatial relationships based on a normal or intended fluid flow direction through sensor 100.

In other cases, it is contemplated that electrolyte pump 120 may be disposed between electrochemical cell 140 and ion selective electrode 150, or even downstream of ion selective electrode 150. The relative placement of electrolyte pump 120 may be varied in order to accommodate manufacturing, performance and other requirements and the like, as long as electrolyte pump 120 is able to provide a desired electrolyte flow, as will be discussed hereinafter.

In some instances, an electrolyte reservoir 110 may be in fluid communication with electrolyte pump 120. In some instances, such as that illustrated in FIG. 1, electrolyte reservoir 110 may be positioned upstream of electrolyte pump 120. It will be recognized, however, that the relative position of electrolyte reservoir 110 may vary, as long as electrolyte pump 120 is able to move electrolyte from electrolyte reservoir 110 and into electrolyte flow channel 130. Electrolyte reservoir 110 may be sized to contain any amount of electrolyte. In many cases, electrolyte reservoir 110 is sized to contain from, for example, about 0.1 to about 1 milliliter of electrolyte.

In some instances, an electrolyte waste reservoir 160 may be disposed downstream of electrolyte flow channel 130. When so provided, sensor 100 may be configured such that electrolyte pump 120 may pump electrolyte from electrolyte reservoir 110 into electrolyte flow channel 130, through electrochemical cell 140, past ion selective electrode 150 and into electrolyte waste reservoir 160. The electrolyte waste reservoir 160 may be sized to contain any amount of electrolyte. In many instances, electrolyte waste reservoir 110 may be sized to contain, for example, about 0.1 to about 2 milliliter of electrolyte. In some cases, it is contemplated that electrolyte waste reservoir 160 may be absent. In such cases, the electrolyte may simply be pumped to the exterior of sensor 100.

Electrolyte pump 120 may be configured to pump electrolyte at a rate that may vary from, for example, about 1 nanoliter per hour to about 100 nanoliters per hour, or perhaps may vary from about 1 nanoliter per minute to about 100 nanoliters per minute, depending on the specific needs of the sensor 100. These, however, are only illustrative pumping rates. In many instances, electrolyte pump 120 is an electrostatically actuated micropump and can include a single micropump or an array of micropumps, as desired. In many cases, electrolyte pump 120 is configured such that its pumping rate may be varied simply by controlling the electrical impulses (e.g. signals) sent to the electrolyte pump 120. Thus, the flow rate of electrolyte through sensor 100 can be adjusted as desired to accommodate a required response time and/or sensitivity.

Ion selective electrode 150 may be any suitable electrode that is capable of detecting the chloride ions that are produced within the electrochemical cell 140, as will be discussed hereinafter. In some cases, ion selective electrode 150 may be an Ag/AgCl reference electrode. The electrode potential of an Ag/AgCl reference electrode may be given by the half-reaction:
AgCl(s)+e⁻⇄Ag(s)+Cl⁻.

Other structures may also be used as ion selective electrode 150. In some cases, ion selective electrode 150 may be an ion selective field effect transistor, or ISFET. A suitable ISFET may be a chlorine ion selective field effect transistor that includes a membrane over a gate area with a methyl tridodecyl ammonium chloride ionophore, as described in “Integrated Probe for Sweat Analysis,” Bezegh et al., Journal of Clinical Laboratory Analysis 2:16-18 (1988), which is incorporated herein by reference. A chloride ion selective field effect transistor can provide an output signal that is relational to a specified concentration of chloride ions in the electrolyte which is itself relational to a concentration of chloride dioxide present in a source sample.

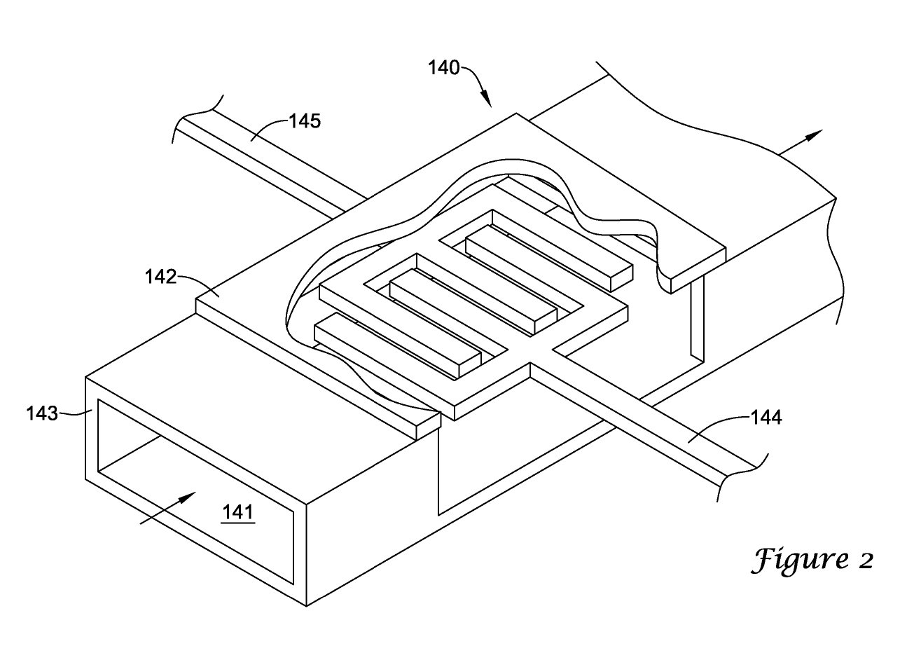

FIG. 2 is a schematic perspective view of an illustrative electrochemical cell 140. The illustrative electrochemical cell 140 provides amperometric reduction of chlorine or chlorine dioxide and can provide an amperometric measurement of chlorine dioxide concentration. Amperometric measurements imply the measurement of a current through an electrode at a given electrical potential due to the reduction or oxidation of a molecule at the electrode.

Some selectivity can be obtained by controlling the potential of the electrode. In many cases, sensitivity of the direct amperometric approach are about 0.1 to 0.5 parts per million. One advantage of this technique is that the number of electrons measured (through the current) is proportional to the number of molecules present. The electrodes required for this detection method can be included on a micro-fabricated device through a photolithographic patterning and metal deposition process.

The electrochemical cell 140 may include an electrolyte flow channel 141 defined at least in part by the electrolyte flow channel wall 143. Electrolyte flow channel 141 may be considered as being in fluid communication with electrolyte flow channel 130, as discussed with respect to FIG. 1. Electrolyte flow is indicated by the arrows through the electrolyte flow channel 141.

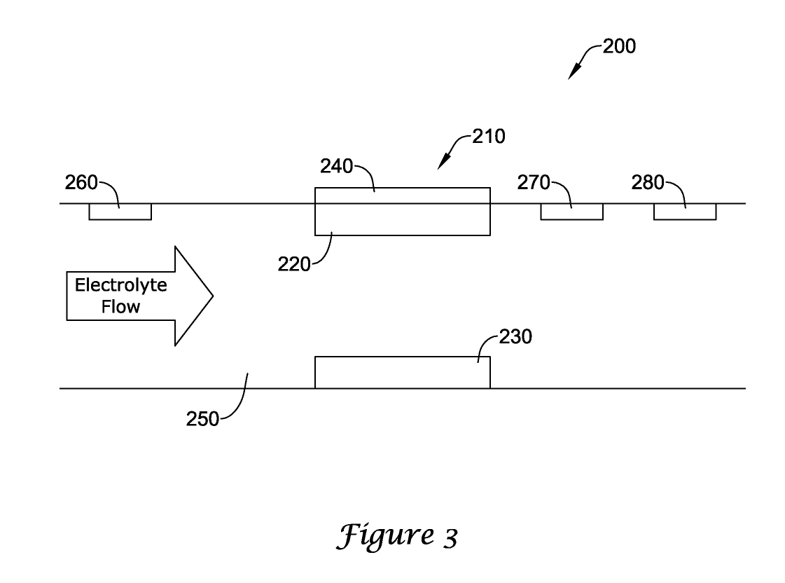

In the illustrative embodiment shown in FIG. 2, a gold cathode 145 and a platinum anode 144 are disposed adjacent a gas permeable membrane 142 and in the electrolyte flowing through the electrolyte flow channel 141. As illustrated, gold cathode 145 and platinum anode 144 are inter-digitized and are at least substantially co-planar. It will be recognized that the specific configuration of gold cathode 145 and/or platinum anode 144 may be modified to accommodate particular manufacturing and/or performance requirements. Moreover, FIG. 3, which will be discussed subsequently, illustrates another possible configuration for gold cathode 145 and platinum anode 144.

In many instances, an analyte such as, for example, chlorine dioxide can diffuse through the gas permeable membrane 142 and into the electrolyte from a chlorine dioxide source. In some embodiments, the chlorine dioxide source is an enclosed space source such as, for example, an office space, a factory space, a warehouse space, or the like.

In many cases, the electrochemical cell 140 is based on amperometric reduction of chlorine dioxide by applying a voltage between gold cathode 145 and platinum anode 144. In this device Cl₂ and/or ClO₂ are reduced to chloride ions (Cl⁻) at the gold cathode as follows:
ClO₂+5e⁻→Cl⁻+O₂
Cl₂+2e⁻→Cl⁻+O₂.
However, the chloride ions are not “scavenged” by the anode and instead concentrate within the electrolyte up to a saturation limit of the chloride salt. Thus, electrochemical cell 140 may “pre-concentrate” the chloride ions that can then be measured by the ion selective electrode 150, as described above.

Chlorine dioxide concentration can be determined since the cathode reaction keeps the chlorine dioxide concentration at substantially zero in the electrolyte, the flux of chlorine dioxide into the electrolyte volume flowing through the electrochemical cell is diffusion rate controlled by the chlorine dioxide source concentration and the chloride concentration will rise to the saturation limit of the chloride salt (depending on the electrolyte flow rate). Therefore, the chloride ion concentration within the electrolyte moving downstream from electrochemical cell 140 is proportional to the atmospheric chlorine dioxide concentration at issue.

The concentration of chlorine dioxide at the source can be determined by direct amperometric measurement for higher concentrations (e.g. 0.5 part per million to 10,000 parts per million of chlorine dioxide or greater than 1 part per million of chlorine dioxide), and concentration of chlorine dioxide at the source can be determined by the ion selective electrode measurement for lower concentrations (e.g. 0.01 part per million to 1 part per million of chlorine dioxide or less than 1 part per million of chlorine dioxide).

Steady state chloride concentration can be determined via ion selective electrode 150 by knowing several fixed parameters such as, for example, exposed gas permeable membrane area, electrolyte volume, membrane permeability, electrolyte flow rate, and potentiometric value.

When so configured, sensor 100 can provide a wide dynamic range during operation, with both direct amperometric measurement for higher chlorine dioxide concentrations (e.g. greater than 1 part per million), or through the downstream ion selective electrode 150 measurement for lower concentrations of chlorine dioxide (e.g. less than 0.1 part per million), all with the same sensor, thus reducing the need for multiple, concentration-specific sensors. In some instances, by combining microfluidics and a chloride ion selective field effect transistor, higher selectivities can be obtained by eliminating interferences from other potential oxidizing agent such as oxygen and ozone.

Electrical connection between gold cathode 145 (working electrode) and platinum anode 144 (counter electrode) is maintained through the electrolyte. The electrolyte may have several different functions. Examples of functions provided by the electrolyte include efficiently carrying ionic current between gold cathode 145 and platinum anode 144. Other functions include solubilizing chloride ion, supporting the cathode reaction, and forming a stable reference potential with any reference electrode. Suitable properties for the electrolyte include electrochemical inertness, ionic conductivity, chemical inertness, temperature stability, low cost, low toxicity, low flammability, and/or appropriate viscosity.

The electrolyte can include any useful material or material combination to support electrochemical reduction of an analyte such as, for example, chlorine dioxide. In many instances, the electrolyte may include a chlorate salt or perchlorate salt dissolved in an appropriate solvent.

In some embodiments, the sensor can operate in a self-calibration mode. Self-calibration may be performed by applying an electrolyte reducing amount of energy (e.g. voltage and/or current) to the electrolyte to release a known amount of chloride ions from the electrolyte and then calibrate the electrochemical cell 140 and/or ion selective electrode 150.

In one example, the chlorate and perchlorate salts present in the electrolyte may be highly conductive but are also capable of being reduced to chloride ions at higher potential (higher than the potential needed to reduce chlorine dioxide.) By using a known concentration of a suitable electro-active salt, such as the chlorate or perchlorate salt, the sensor can operate in two modes. At low applied potential, chlorine dioxide is reduced to chloride ions and sensor 100 operates as discussed previously. At higher applied potentials, the chlorate or perchlorate electrolyte may also be reduced.

Since the concentration of this electrolyte salt is known, the resulting current at electrochemical cell 140 and the increased concentration of chloride ions at ion selective electrode 150 will be highly predictive and useable as a test and calibration standard. The unknown chloride ion concentration can be resolved mathematically by subtracting the signal at the two applied potentials. In this manner, the system can be tested and calibrated “at will” by a controller by simply modifying the applied potential.

FIG. 3 is a schematic diagram of a portion of an illustrative sensor 200. It is considered that sensor 200 may represent an alternative embodiment to flow channel 130, electrochemical cell 140 and ion selective electrode 150 as illustrated in FIG. 1. Thus, while only a portion of sensor 200 is shown, sensor 200 may be considered as including pump 120 and electrolyte reservoir 110 disposed upstream as well as electrolyte waste reservoir 160 disposed downstream, as discussed with respect to FIG. 1.

Sensor 200 includes an electrochemical cell 210. Electrochemical cell 210 includes a gas permeable membrane 240 that may be configured to permit gaseous chlorine dioxide present in an atmosphere exterior to sensor 200 to diffuse into sensor 200. Electrochemical cell 210 includes a gold cathode 220 that is disposed underneath gas permeable membrane 240. In some instances, gold cathode 220 may be porous. In some cases, gold cathode 220 may be formed or configured to include small apertures or passages that are sufficiently large to permit gaseous chlorine dioxide to pass through.

In some cases, it is contemplated that gold cathode 220 may be formed by creating a large number of small holes through a thin solid block of material. The block may be gold, or may be another material that is coated with gold. In some instances, gold cathode 220 may be a gold mesh or a gold-plated mesh. If gold cathode 220 is a gold-plated mesh, any suitable metal such as nickel may be used as the structural component of gold cathode 220.

Electrochemical cell 210 also includes a platinum anode 230. In some instances, platinum anode 230 may be disposed along or near a bottom of a flow channel 250 while gold cathode 220 is disposed along or near a top of flow channel 250. Flow channel 250 may be similar in size and shape to flow channel 130, as discussed with respect to FIG. 1, and may be in fluid communication with one or more of pump 120, electrolyte reservoir 110 and/or electrolyte waste reservoir 160.

In some instances, sensor 200 may include an upstream ion selective electrode 260. Upstream ion selective electrode 260 may be any suitable device that may be adapted to measure or detect chloride ion concentration and thus may be used to detect chloride ions that are present within the electrolyte upstream of electrochemical cell 210. Sensor 200 may employ an electrolyte such as those discussed previously with respect to FIG. 2. In some cases, upstream ion selective electrode 260 may be an Ag/AgCl reference electrode as discussed with respect to ion selective electrode 150 (FIG. 1). Upstream ion selective electrode 260 may be a reference electrode to platinum anode 230.

Sensor 200 may, if desired, include one or more downstream ion selective electrodes. As illustrated, sensor 200 includes a first downstream ion selective electrode 270 and a second downstream ion selective electrode 280. In other instances, sensor 200 may include only a single downstream ion selective electrode. In some cases, sensor 200 may include three or more downstream ion selective electrodes. Using more than one downstream ion selective electrode may be useful in accounting for spatial differences in chloride ion concentration within the electrolyte downstream of electrochemical cell 210.

In some instances, first downstream ion selective electrode 270 and/or second downstream ion selective electrode 280 may be any suitable device that may be used to detect chloride ions. In some cases, first downstream ion selective electrode 270 and/or second downstream ion selective electrode 280 may each be an Ag/AgCl reference electrode. First downstream ion selective electrode 270 and second downstream ion selective electrode 280 may each be reference electrodes to platinum anode 230.

The present invention should not be considered limited to the particular examples described above, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

What is claimed is:

1. A chlorine dioxide sensor comprising:
an electrolyte flow channel;
a gas permeable membrane disposed adjacent the electrolyte flow channel;
a gold cathode disposed in the electrolyte flow channel;
a platinum anode disposed in the electrolyte flow channel;
an electrostatically actuated pump in fluid communication with the electrolyte flow channel; and
an ion selective electrode disposed within the electrolyte flow channel downstream of the gold cathode.

2. The chlorine dioxide sensor of claim 1, wherein the gold cathode and the platinum anode are inter-digitized and are disposed adjacent the gas permeable membrane.

3. The chlorine dioxide sensor of claim 1, wherein the gold cathode is disposed adjacent the gas permeable membrane and the platinum anode is disposed across the flow channel from the gold cathode.

4. The chlorine dioxide sensor of claim 3, wherein the gold cathode comprises a gold or gold plated mesh.

5. The chlorine dioxide sensor of claim 1, further comprising an electrolyte reservoir disposed upstream of the gold cathode.

6. The chlorine dioxide sensor of claim 1, further comprising an electrolyte waste reservoir disposed downstream of the ion selective electrode.

7. The chlorine dioxide sensor of claim 1, further comprising an upstream Ag/AgCl reference electrode disposed upstream of the gold cathode.

8. The chlorine dioxide sensor of claim 7, further comprising a downstream Ag/AgCl reference electrode disposed downstream of the ion selective electrode.

9. The chlorine dioxide sensor of claim 1, wherein the electrolyte reservoir is configured to contain about 0.1 to about 1 milliliter of an electrolyte comprising a chlorate salt and/or a perchlorate salt.

10. The chlorine dioxide sensor of claim 1, wherein the electrostatically actuated pump is configured to pump electrolyte at a rate that ranges from about 1 nanoliter per hour to about 100 nanoliters per hour.

11. A sensor comprising:
an electrochemical cell;
an ion selective electrode; and
a pump in fluid communication with the electrochemical cell and the ion selective electrode.

12. The sensor of claim 11, further comprising an upstream reference electrode disposed upstream of the electrochemical cell.

13. The sensor of claim 12, further comprising a downstream reference electrode disposed downstream of the ion selective electrode.

14. The sensor of claim 11, wherein the electrochemical cell comprises a flow channel and a gas permeable membrane in fluid communication with the flow channel.

15. The sensor of claim 14, wherein the electrochemical cell further comprises a gold cathode and a platinum anode disposed in the flow channel.

16. A method of detecting chlorine dioxide in an atmosphere, comprising the steps of:
pumping an electrolyte through an electrochemical cell using a pump, the electrochemical cell comprising a flow channel, a gas permeable membrane disposed adjacent the flow channel, and a gold cathode and a platinum anode disposed in the flow channel;
exposing the gas permeable membrane to the atmosphere, thereby permitting chlorine dioxide in the atmosphere, if present, to diffuse into the electrolyte;
reducing the diffused chlorine dioxide into chloride ions at the gold cathode; and
determining the chlorine dioxide concentration based on the chloride ion concentration within the electrolyte.

17. The method of claim 16, wherein the determining step comprises measuring a direct amperometric output from the electrochemical cell.

18. The method of claim 16, wherein the determining step comprises measuring a voltage at a first downstream reference electrode disposed downstream of the electrochemical cell.

19. The method of claim 18, wherein the determining step further comprises subtracting a voltage at a reference electrode upstream of the electrochemical cell.

20. The method of claim 18, wherein the determining step further comprises using a second downstream reference electrode disposed downstream of the electrochemical cell to account for spatial concentration differences in chloride ion concentration.

21. The method of claim 16, wherein the pumping step comprises adjusting the electrolyte flow rate by changing the pumping rate of the pump.

22. The method of claim 16, further comprising a calibration step comprising applying energy to the electrolyte to release a known amount of chloride ions.

23. A chlorine dioxide detection network comprising a plurality of the sensors of claim 11 in communication with a wired or wireless network.
